(19) United States
(12) Patent Application Publication
(10) Pub. No.: US 2011/0039005 A1
(43) Pub. Date: Feb. 17, 2011

(54) METHOD FOR PRODUCING AN EDIBLE STIRRING INSTRUMENT AND INSTRUMENT MADE BY MEANS OF SAID METHOD

(75) Inventor: Jordi Nevot Banus, Castellar Del Valles (ES)

Correspondence Address: KNOBBE MARTENS OLSON & BEAR LLP, 2040 MAIN STREET, FOURTEENTH FLOOR, IRVINE, CA, 92614, US

(73) Assignee: SUCSPOONWORKSHOP. S.L., Sant Fruitos De Bages (ES)

(21) Appl. No.: 12/674,318

(22) PCT Filed: Aug. 20, 2007
(86) PCT No.: PCT/ES07/00490

§ 371 Date: Feb. 19, 2010

(51) Int. Cl. A21D 13/00

(52) U.S. Cl. 426/549

(57) ABSTRACT

The invention relates to a method for obtaining an edible stirring instrument and an instrument obtainable by means of said method, which comprises configuring a body (1) of elongated configuration and reduced size from an edible food product dough, subjecting it to the action of heat until said body (1) has lost sufficient moisture to reach an optimal degree of cooking, and putting a sweetening and/or flavoring product (4) in said body (1), thereby achieving a tool which allows stirring beverages, such as coffee for example, and the subsequent consumption thereof by the user.

### OBJECT OF THE INVENTION

A first aspect of the present invention relates to a method for obtaining an edible stirring instrument, and a second aspect of the invention relates to an edible stirring instrument obtainable by means of said method, being applicable in the food industry, allowing obtaining with a reduced cost and in an effective manner an instrument which allows sweetening and/or giving flavor to beverages, creams, purées or paps, making use of said instrument for its subsequent consumption by the user, with the consequent appreciation by such user, thus preventing all the operations related to discarding said instrument, with the consequent economic saving that this entails.

### BACKGROUND OF THE INVENTION

Various devices and instruments are currently known which allow stirring a beverage, especially to dissolve a sweetening product, such as sugar for example, in beverages such as coffee or tea, which is usually carried out with small-sized spoons.

Devices are also known which allow giving flavor to a beverage, which is usually performed by means of putting the flavoring substance in a housing which allows the liquid to be impregnated with said flavoring substance, while at the same time a complete mixing is prevented, i.e., retaining the flavoring substance, which usually comprises solid elements such as leaves cut into pieces, in said housing to prevent its mixing with the liquid, which is unpleasant.

In the catering sector, the spoons used to stir or mix beverages are usually metallic, whereby it is necessary to have personnel for the operations of recovering and washing said instruments after their use by the user, with the consequent cost that this entails.

On the other hand, especially in the transport sector, such as in the meal or catering services in air transport, said spoons have to be of plastic, which entails at least their removal and storage during the flight, with the consequent inconvenience, especially considering the requirements relative to load and space required by this type of transport.

Various inventions, which are set forth below, have arisen for the purpose of solving these drawbacks, i.e., unifying in one and the same utensil a sweetening product and an instrument for stirring and dissolving it in beverages.

Spanish utility model with publication number ES-1059718-U relates to an edible sweetening spoon which gradually dissolves when a user stirs a beverage such as coffee or tea. Said spoon is formed by two parts, a functional part having an oval shape and made of a sweetening product and a handle which is also made of an edible although not necessarily soluble product, such as chocolate or cookie.

Likewise, Spanish utility model with publication number ES-1061351-U relates to an edible sweetening and/or flavoring stirrer for beverages, which is configured to sweeten or give flavor to a beverage, allowing a subsequent stirring of a beverage, after which said stirrer can be consumed by the user.

This stirrer comprises an outer container body, which can be of cookie, chocolate or candy, with a tubular shape obturated at its ends and containing a sweetening product therein.

Spanish utility model with publication number ES-1063369-U relates to an edible sweetening and/or flavoring spoon-stirrer for beverages having the same purposes and use as the previous one, having differences in relation to its configuration.

This spoon-stirrer is made by means of a holding body for an edible material which has the configuration of a plate with an elongated shape which at one of its ends has a recess in which it bears a sweetening product. The spoon comprises an edible handle having a recess or hollow which is capable of bearing a sweetening product or any other soluble product in tablet form. The composition of the holding body will be of an edible material, of an appreciable consistency and not easily softened, to allow stirring the liquid, and of an easy and pleasant ingestion.

To obtain the aforementioned devices, the performance of a series of operations is required which involve the need to make slots or openings in the holding body, with the consequent loss of time and risk of such body breaking.

On the other hand, during the operations of transport to the point of use in a cafeteria, restaurant or airplane, a detachment of the sweetening product usually occurs, given its arrangement in the body, for which these devices have no means for retaining it.

Finally, these devices also do not comprise means which effectively prevent the softening of the holding body when it is in the presence of the liquid of the beverage, an effect which increases with the temperature, said process being accelerated when the beverage is hot, whereby the instrument loses its functionality for stirring the beverage.

### DESCRIPTION OF THE INVENTION

A first aspect of the present invention relates to a method for obtaining an edible stirring instrument, and a second aspect of the invention relates to an edible stirring instrument obtainable by means of said method, which allow obtaining an effective instrument which, at the same time as it gives flavor and/or sweetens, allows stirring beverages, creams, purées or paps, all of this by means of a series of steps having a reduced cost, said instrument being made us of for its subsequent consumption by the user, with the consequent appreciation by such user, thus preventing all the operations related to discarding said instrument, with the consequent economic saving that this entails, especially in the catering sector.

The method for obtaining an edible stirring instrument proposed by the invention comprises the following steps:
a) configuring a body of elongated configuration from an edible dough comprising at least one food product, said body preferably having a one-piece configuration so that its manufacture is quick,
b) subjecting the body to an operatively controlled action of heat, which is preferably carried out in an oven, until said body has lost sufficient moisture to reach an optimal degree of cooking, and
c) putting, either by coating, inserting or embedding, at least one sweetening and/or flavoring product, such as sugar or sucralose for example, in said body.

In the present description, optimal degree of cooking is understood as that state or condition in which the dough from which the body is obtained is sufficiently rigid, strong or resistant to maintain a rigid solid configuration, having sufficient resistance to maintain its rigidity in the presence of a liquid, when the instrument obtained by means of said method is used to stir a beverage.

Although a preferred application of the edible instrument obtainable by means of the described method is stirring beverages, such as coffee or tea, to dissolve a sweetening product such as sugar, the possibility of using said instrument like a spoon to contain small doses of any other food, such as ice cream for example, for the consumption thereof by the user, is contemplated.

The instrument thus obtained is formed by a single body of edible and therefore biodegradable material which is configured to be used as a spoon and/or stirrer, being able to adopt any size and shape in the previously described step a).

The possibility is also contemplated that the product dough comprises any type or mixture of food products, such as for example chocolate, candy or cookie dough which can be obtained from different mixtures filled with chocolate, vanilla, butter, etc., as well as any type of flour or nuts, whereas the flavoring product can comprise any type of flavor, such as for example chocolate, orange, mint, lemon, etc.

In step b) the cooking is carried out, the characteristics of which allow the mass to acquire sufficient resistance to softening in the presence, i.e., in contact with the liquid.

The possibility is contemplated that after step b), the method of the invention comprises applying to the body a glossy or matte surface finish comprising an impermeable film. The body thus has in its entire outer contour an impermeability layer for the purpose of preventing the cookie from being quickly impregnated with liquid, thus reinforcing its resistance to softening which allows it to continue fulfilling its function as an instrument for an even more prolonged period.

The impermeable film described in the previous paragraph is preferably by obtained by the dehydration of a solution of hydrocolloids, which confers to it a greater impermeabilization capacity.

The possibility is also contemplated that step c) comprises coating a proximal end of the body with a gelatinous substance comprising the sweetening and/or flavoring product. Said gelatinous substance is then allowed to dry until its solidification, whereby this already solidified gelatinous substance is finally configured to dissolve in the presence of liquid.

The body of edible material is thus covered at one of its ends by a gelatinous substance in solid state which incorporates in its mixture a necessary amount of sweetener and which will be dissolved in contact with any liquid.

The gelatinous substance preferably comprises a solution of carbohydrates, fiber, hydrocolloids, as well as the sweetening and/or flavoring product.

By means of gelling said solution of carbohydrates, fiber and hydrocolloids which incorporate the sweetener, or the different mixtures of possible flavors, one of the ends of the body, preferably the end opposite to the one which is intended for the grip or holding of the instrument, is covered.

Said gelling is a solidification of a liquid or essentially liquid paste when it cools, which depends on the viscosity of the liquid, on the level of sweetener and drying time. Once solidified, said gelatinous substance subsequently redissolves, i.e., it returns to a liquid state, when it is in the presence of any liquid, either cold or hot, giving the desired degree of sweetness or flavor to the beverage.

The possibility is contemplated that the proximal end of the body has at least one cavity or orifice configured to house the sweetening and/or flavoring product.

Thus, the area of the body which is covered by the gelatin incorporated one or a plurality of cavities or holes allowing, depending on the number of cavities, a higher concentration of sweetener, and therefore a regulation of the degree of sweetness which the instrument can provide.

Furthermore, the gelatinous substance can incorporate in its mixture the different flavors which the flavoring product can have, such as for example chocolate, orange, mint, lemon, etc., depending on the different products for which it is intended, such as tea, coffee, chamomile tea, milk, etc.

Obtaining this instrument by means of the method of the invention allows reducing the costs in the manufacturing process since work is done at all times with a single piece, obtaining in a single product four functionalities which provide an added value to the act of consumption, for example, of a cup of coffee, having a spoon, cookie, chocolate and sugar in a single product.

The incorporation of the gelatin thus prevents the detachment of the sweetener in the transport, which is a manifest drawback in the devices of the state of the art.

According to an embodiment variant of the invention, it is contemplated that before step b) the method comprises a step b1) which comprises making a cavity in the body and inserting said at least one sweetening and/or flavoring product in said cavity.

Likewise, the method can comprise, after step b1), a step b2) which comprises blinding the cavity by means of a sealing element. Said sealing element is preferably obtained from the same edible dough as the body, although it can be of any other substance, for example the body can be of cookie dough and the sealing element of chocolate.

According to a preferred embodiment, the configuration of the body in step a) is such that the size and the obtained shape of said body allow stirring beverages contained in a glass and/or a cup, i.e., the obtainable instrument has a small size.

A second aspect of the present invention relates to an edible stirring instrument obtainable by means of any of the previously described methods, being able to have any configuration in terms of shape, preferably being planar with an elongated, oval, rectangular, bent or tubular plan.

According to a preferred embodiment of the instrument proposed by the invention, the body is planar and has an oval plan, having a proximal end and a distal end of blunt configuration, said distal end being configured for the holding of the instrument by a user.

### DESCRIPTION OF THE DRAWINGS

To complement the description which is being made and for the purpose of aiding to better understand the features of the invention according to a preferred practical embodiment thereof, a set of drawings is attached as an integral part of said description, in which the following has been depicted with an illustrative and non-limiting character:

FIG. 1 shows a longitudinal section, according to an elevational view, of a preferred embodiment of the stirring instrument obtainable by means of the method proposed by the invention.

FIG. 2 shows a perspective view of an embodiment variant of the instrument obtainable by means of the method of the invention.

### PREFERRED EMBODIMENT OF THE INVENTION

In view of the indicated figures, it can be observed how in one of the possible embodiments of the first aspect of the invention, the method for obtaining an edible stirring instrument comprises the following steps:
a) configuring a body (1) of elongated configuration from an edible dough comprising at least one food product,
b) subjecting the body (1) to an operatively controlled action of heat in an oven until said body (1) has lost sufficient moisture to reach an optimal degree of cooking, and
c) putting at least one sweetening and/or flavoring product (4) in said body (1).

The product dough comprises cookie dough, as well as flour, whereas the sweetening product (4) is sugar.

After step b), the method of the invention comprises applying to the body (1) a glossy surface finish comprising an impermeable film obtained by the dehydration of a solution of hydrocolloids, which confers to it a greater impermeabilization capacity.

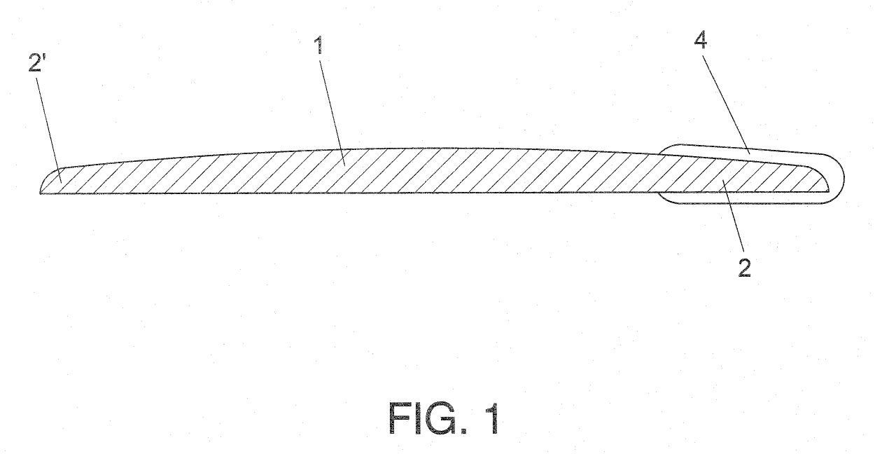

Likewise, step c) comprises coating a proximal end (2) of the body (1) with a gelatinous substance comprising a solution of carbohydrates, fiber, hydrocolloids, as well as the sweetening and/or flavoring product (4), as can be observed in FIG. 1. Said gelatinous substance is then allowed to dry until its solidification, whereby this already solidified gelatinous substance is finally configured to dissolve in the presence of liquid.

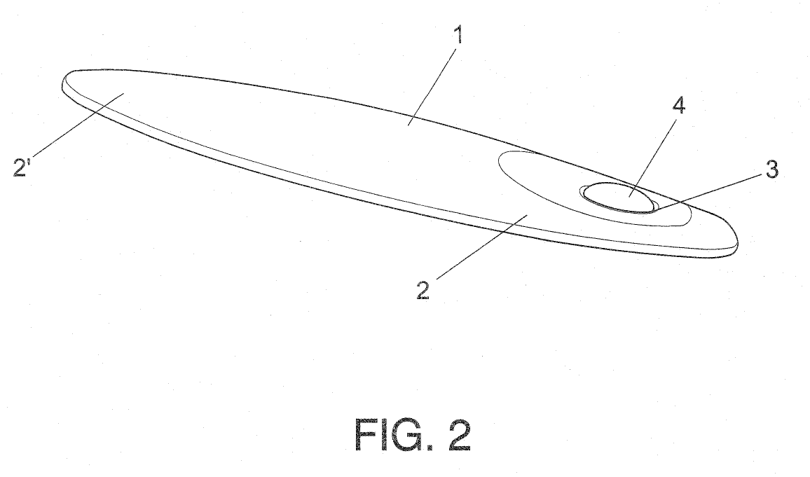

According to an embodiment variant of the invention, to obtain an instrument depicted in FIG. 2, before step b) the method comprises a step b1) which comprises making a cavity (3) in the body (1) and inserting said at least one sweetening and/or flavoring product (4) in said cavity (3). This method comprises, after step b1), a step b2) which comprises blinding said cavity (3) by means of a sealing element which is obtained from the same edible dough as the body (1).

A second aspect of the present invention relates to an edible stirring instrument obtainable by means of any of the previously described methods.

As can be observed in FIG. 1, the edible stirring instrument comprises a planar body (1) having an oval plan, having a proximal end (2) and a distal end (2′) of blunt configuration, said distal end (2′) being configured for the holding of the instrument by a user. As can be observed in said FIG. 1, the proximal end (2) is coated with a sweetening product (4).

FIG. 2 shows an embodiment variant of the instrument obtainable by means of the method of the invention, in which the sweetening product (4) arranged in a cavity (3) which the body (1) has at a proximal end (2) can be observed.

In view of this description and set of figures, the person skilled in the art will understand that the embodiments of the invention which have been described can be combined in many ways within the object of the invention. The invention has been described according to several preferred embodiments thereof, but for the person skilled in the art it will be evident that multiple variations can be introduced in said preferred embodiments without exceeding the object of the claimed invention.

1. Method for obtaining an edible stirring instrument, comprising the following steps:
a) configuring a body of elongated configuration from an edible dough comprising at least one food product,
b) subjecting the body to an operatively controlled action of heat until said body has lost sufficient moisture to reach an optimal degree of cooking, and
c) putting at least one sweetening and/or flavoring product in the body.

2. Method according to claim 1, which after step b) comprises applying to the body a surface finish comprising an impermeable film.

3. Method according to claim 2, wherein the surface finish is glossy.

4. Method according to claim 2, wherein the surface finish is matte.

5. Method according to claim 2, wherein the impermeable film is obtained by the dehydration of a solution of hydrocolloids.

6. Method according to claim 1, wherein step c) comprises coating a proximal end of the body with a gelatinous substance comprising said at least one sweetening and/or flavoring product, drying said gelatinous substance until its solidification, said solidified gelatinous substance being configured to dissolve in the presence of liquid.

7. Method according to claim 6, wherein the gelatinous substance comprises a solution of carbohydrates, fiber, hydrocolloids and said at least one sweetening and/or flavoring product.

8. Method according to claim 6, wherein the proximal end has at least one cavity configured to house said at least one sweetening and/or flavoring product.

9. Method according to claim 1, which before step b) comprises a step b1) which comprises making a cavity in the body and inserting said at least one sweetening and/or flavoring product in said cavity.

10. Method according to claim 9, which after step b1) comprises a step b2) which comprises blinding the cavity by means of a sealing element.

11. Method according to claim 10, wherein the sealing element is obtained from the same edible dough as the body.

12. Method according to claim 1, wherein the configuration of the body in step a) is such that the size and the obtained shape of said body allows stirring beverages contained in a glass and/or a cup.

13. Edible stirring instrument obtainable by means of claim 1.

14. Instrument according to claim 13, wherein the body is planar and has an oval plan, having a proximal end and a distal end of blunt configuration, said distal end being configured for the holding of the instrument by a user.
